(19) United States
(12) Patent Application Publication
(10) Pub. No.: US 2024/0305438 A1
(43) Pub. Date: Sep. 12, 2024

(54) ANTENNA TRACKER ARCHITECTURE FOR AN ELECTRICAL BALANCED DUPLEXER

(71) Applicant: Apple Inc., Cupertino, CA (US)

(72) Inventors: Josef W. Koller, Burglengenfeld (DE); Bjoern Lenhart, Nürnberg (DE); Dominic Koehler, Viereth-Trunstadt (DE)

(21) Appl. No.: 18/435,812

(22) Filed: Feb. 7, 2024

Related U.S. Application Data
(60) Provisional application No. 63/451,102, filed on Mar. 9, 2023.

(51) Int. Cl. H04L 5/14; H04B 1/40

(52) U.S. Cl. CPC H04L 5/14; H04B 1/40

(57) ABSTRACT

A communication device includes an antenna tracker having a circuit architecture that includes at least one L-C resonance circuit component with an adjustable resonance frequency value. In particular, each of the L-C resonance circuit components may include a tunable capacitor and an inductor coupled in parallel. The antenna tracker may be single-ended and include at least one ground coupling, while in some embodiments, the antenna tracker may be differential. The circuit architecture of the antenna tracker may enable the antenna tracker to increase an impedance coverage range of the communication device, thus increasing a range of impedance within which an antenna impedance may be effectively tracked and matched, enabling effective isolation between the transmitter and receiver across an increased range of antenna impedance.

### CROSS-REFERENCE TO RELATED APPLICATIONS

This application claims priority to U.S. Application No. 63/451,102, entitled “ANTENNA TRACKER ARCHITECTURE FOR AN ELECTRICAL BALANCED DUPLEXER,” filed Mar. 9, 2023, which is hereby incorporated by reference in its entirety for all purposes.

### BACKGROUND

The present disclosure relates generally to wireless communication, and more specifically to isolation of wireless signals between transmitters and receivers in wireless communication devices.

In an electronic device, a transmitter and a receiver may each be coupled to one or more antennas to enable the electronic device to both transmit and receive wireless signals. The electronic device may include a duplexer that isolates the transmitter from received signals of a first frequency range, and isolates the receiver from transmission signals of a second frequency range (e.g., thus implementing frequency division duplex (FDD) operations). In this manner, interference between the transmission and received signals may be reduced when communicating using the electronic device. However, these communications may be negatively impacted by insertion loss resulting from components of the duplexer providing less than ideal isolation of the transmission and/or received signals.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a communication device is described. The communication device may include one or more antennas, communication circuitry, and isolation circuitry coupling the one or more antennas to the communication circuitry. Furthermore, the isolation circuitry may include an antenna tracker having a first L-C resonance circuit coupled in parallel with a second L-C resonance circuit.

In another embodiment, a radio frequency front end circuitry is described. The radio frequency front end circuitry may include transmitter circuitry, receiver circuitry, and isolation circuitry configured to couple the transmitter circuitry and the receiver circuitry to one or more antennas. Furthermore, the isolation circuitry may include a first impedance tank, a second impedance tank, a third impedance tank. and a fourth impedance tank coupled in a first X-section circuit configuration.

In yet another embodiment, an antenna tracker is described. The antenna tracker may include a first L-C resonance circuit, a second L-C resonance circuit coupled in parallel with the first L-C resonance circuit, and a third L-C resonance circuit coupled to the first L-C resonance circuit and the second L-C resonance circuit. Furthermore, the first L-C resonance circuit, the second L-C resonance circuit, and the third L-C resonance circuit may each include a tunable capacitor coupled in parallel with an inductor.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a radio frequency front end (RFFE) of the electronic device of FIG. 1, according to embodiments of the present disclosure;

FIG. 4 is a schematic diagram of a transmitter of the electronic device of FIG. 1, according to embodiments of the present disclosure;

FIG. 5 is a schematic diagram of a receiver of the electronic device of FIG. 1, according to embodiments of the present disclosure;

FIG. 6 is a circuit diagram of a single-ended antenna tracker of the electronic device of FIG. 1 including one or more L-C resonance circuit components disposed on one or more shunt branches, according to embodiments of the present disclosure;

FIG. 7 is a circuit diagram of a single-ended antenna tracker of the electronic device of FIG. 1 including one or more L-C resonance circuit components disposed on one or more shunt branches and one or more serial branches, according to embodiments of the present disclosure;

FIG. 8 is a circuit diagram of a differential antenna tracker of the electronic device of FIG. 1 including one or more impedance tanks coupled in an X-section architecture, according to embodiments of the present disclosure;

FIG. 9 is a circuit diagram of a differential antenna tracker of the electronic device of FIG. 1 including two X-section architectures coupled in series, according to embodiments of the present disclosure;

FIG. 10 is a circuit diagram of an antenna tracker of the electronic device of FIG. 1 including one or more single-ended impedance tuners coupled to an X-section architecture, according to embodiments of the present disclosure; and

FIG. 11 is a Smith diagram of a first impedance coverage range of an antenna tracker having tunable capacitors arranged in parallel compared to a second impedance coverage range of an embodiment of the antenna tracker of FIGS. 6-10, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to isolating wireless signals between a transmitter and a receiver in a wireless communication device using isolation circuitry that includes a duplexer (e.g., an electrical balanced duplexer (EBD), a phase balanced duplexer (PBD), Wheatstone balanced duplexer (WBD), a differential double balanced duplexer (dDBD), a circular balanced duplexer (CBD), or any other duplexer used to isolate wireless signals between transmitters and receivers) having an antenna tracker (e.g., antenna impedance tuner) that isolates the receiver from transmission signals and the transmitter from received signals by tracking and matching changes in the antenna impedance (e.g., via one or more tunable components of the antenna tracker). However, in some embodiments, the range of antenna impedance values that the antenna tracker may track and match may be restricted (e.g., constrained, limited) by components of the antenna tracker and/or an architecture (e.g., formation, structure, couplings, circuit structure) of the antenna tracker (e.g., impedance tuner). For example, certain antenna tracker architectural designs may include one or more tunable capacitors coupled in parallel. However, such designs may only be able to match a limited antenna impedance range (e.g., where variable standing wave ratio (VSWR) coverage may be provided) due to characteristics of the antenna tracker architecture, which may limit a range of sufficient isolation. As such, a radio frequency front end (RFFE) may only operate efficiently in a relatively narrow range of antenna impedance values.

Therefore, embodiments herein provide for a duplexer (e.g., EBD) that includes an antenna tracker (e.g., antenna impedance tuner) having an architecture that includes at least one L-C resonance circuit component. In particular, each of the L-C resonance circuit components may include a tunable capacitor and an inductor coupled in parallel. In some embodiments, the antenna tracker may be single-ended (e.g., include at least one ground coupling), while in additional embodiments, the antenna tracker may be differential. For example, the antenna tracker may be a single-ended antenna tracker that includes one or more L-C resonance circuits each disposed on a respective shunt branch of the antenna tracker and thus coupled in parallel relative to each other. Additionally, in some embodiments, the single-ended antenna tracker may include one or more inductors each coupled in series between two respective shunt branches, and thus each of the one or more inductors may be coupled in series between each L-C resonance circuit. Additionally or alternatively, the single-ended antenna tracker may include one or more of the L-C resonance circuits each coupled in series between two respective shunt branches and thus each L-C resonance circuit coupled in series may be coupled between two respective L-C resonance circuits (e.g., disposed on the shunt branches). Furthermore, each L-C resonance circuit may provide a respective inductive behavior or a respective capacitive behavior based on a desired target impedance (e.g., target impedance based on a detected antenna impedance). In particular, the inductive behavior or capacitive behavior of each of the L-C resonance circuits may be defined by a distinct range of frequencies, with an inductive behavior frequency range having a range of frequency values less than a resonance frequency value, and capacitive behavior having a range of frequency values greater than the resonance frequency value. Moreover, the resonance frequency value associated with each L-C resonance circuit may be adjusted (e.g., changed, shifted) by tuning (e.g., adjusting) a capacitive value of the respective tunable capacitor. In this way, including at least one L-C resonance circuit into the single-ended antenna tracker may enable the single-ended antenna tracker to match an increased range of antenna impedance than the range of antenna impedances covered (e.g., matched) by the previously discussed antenna trackers having tunable capacitors arranged in parallel. Therefore, including the at least one L-C resonance circuit into the single-ended antenna tracker architecture may increase (e.g., extend) an antenna impedance coverage range (e.g., and thus VSWR coverage) of the duplexer, therefore increasing a range of effective isolation between the transmitter and receiver.

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22. an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth. The power source 29 of the electronic device 10 may include any suitable source of power, such as a rechargeable lithium polymer (Li-poly) battery and/or an alternating current (AC) power converter.

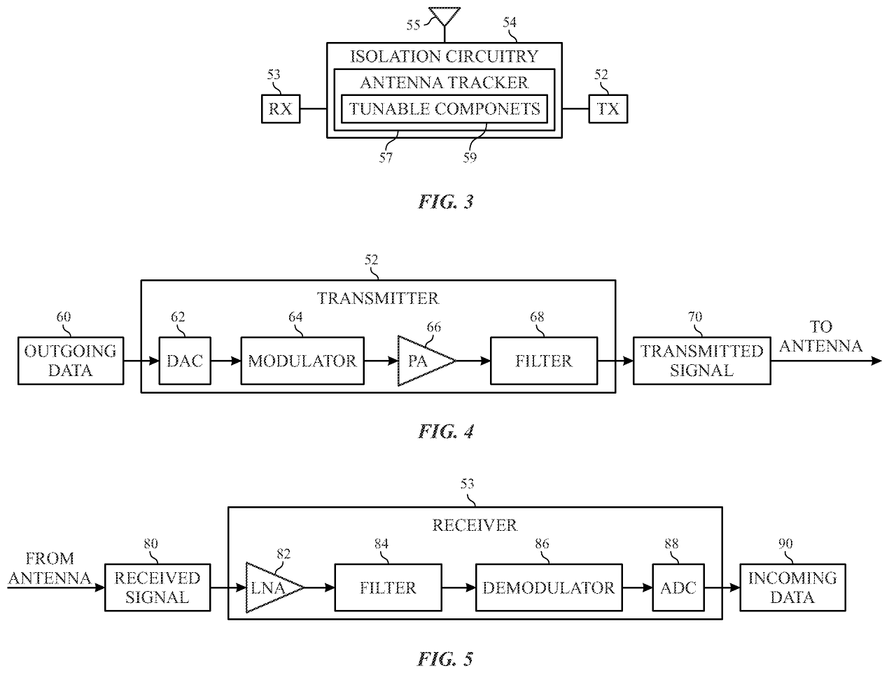

As illustrated, the network interface 26 may include a transceiver 30 (e.g., communication component, communication circuitry). In some embodiments, all or portions of the transceiver 30 may be disposed within the processor 12. The transceiver 30 may support transmission and receipt of various wireless signals via one or more antennas, and thus may include a transmitter and a receiver. The transceiver 30 may be communicatively coupled to the one or more antennas, as well as to isolation circuitry. The isolation circuitry may include an antenna tracker that tracks and matches an impedance (e.g., antenna impedance, antenna input impedance) of the one or more antennas to increase isolation between the transmitter and the receiver of the transceiver 30. In some embodiments, antenna impedance may fluctuate over time (e.g., due to environmental effects). To effectively track and match the antenna impedance, the antenna tracker may include one or more tunable components (as illustrated in FIG. 3) that may be adjusted or tuned (e.g., resistive devices such as resistors, inductive devices such as inductors, capacitive devices such as capacitors, and so on) to adjust a resonance frequency and/or an impedance generated by the antenna tracker that matches the antenna impedance. In particular, the processor 12 may adjust or tune the one or more tunable components based on tuning states and/or a tuning algorithm stored in the memory 14 and/or the storage 16. In some embodiments, the tuning states and/or the tuning algorithm may be determined (e.g., calculated, set) based on a detected VSWR measurement at the one or more antennas. Furthermore, the tuning states of the one or more tunable components may be stored in a data structure saved in the memory 14 (e.g., lookup table) that enable a target isolation range and target insertion loss range associated with the transceiver 30 (e.g., the transmitter and/or the receiver), and/or the one or more antennas. In additional or alternative embodiments, the tuning algorithm may include one or more algorithms that, when performed, enable the processor 12 to adjust or tune the one or more tunable components to achieve the target isolation range and target insertion loss range associated with the transceiver 30 and/or the one or more antennas. The tuning algorithm may include machine-learning processes, optimization algorithms (e.g., nonlinear optimization algorithms, nonconvex optimization algorithms, deterministic global optimization solver algorithms, and so on), or the like.

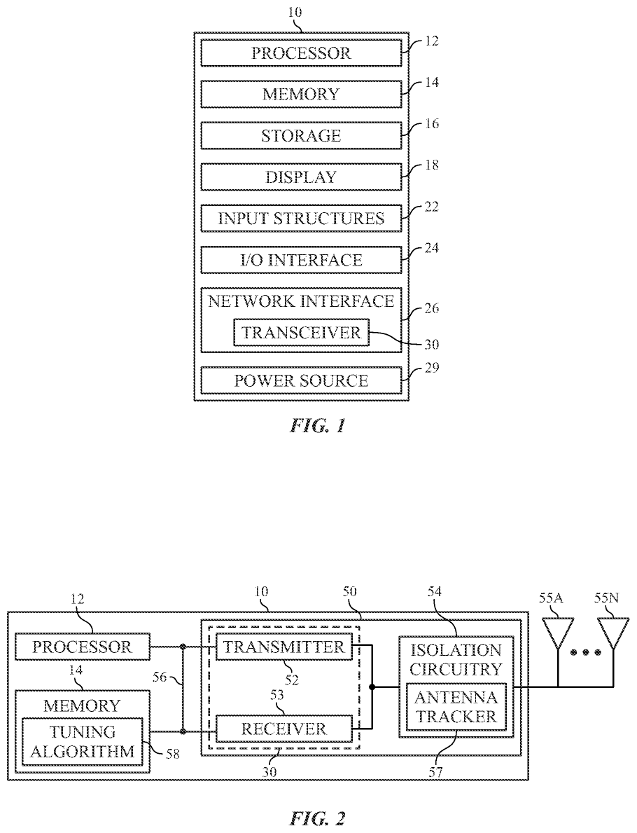

FIG. 2 is a functional diagram of the electronic device 10 of FIG. 1, according to embodiments of the present disclosure. As illustrated, the processor 12, the memory 14, a radio frequency front end (RFFE) 50 having the transceiver 30, which may include one or more communication components (e.g., communication circuitry), and isolation circuitry 54 (e.g., EBD), and/or antennas 55 (illustrated as 55A-55N, collectively referred to as an antenna 55) may be communicatively coupled directly or indirectly (e.g., through or via another component, a communication bus, a network) to one another to transmit and/or receive signals between one another. The communication components may include a transmitter 52 and/or a receiver 53 that may enable communication via transmission and reception of signals.

In particular, the transmitter 52 and/or the receiver 53 may respectively enable transmission and reception of signals between the electronic device 10 and an external device via, for example, a network (e.g., including base stations or access points) or a direct connection. As illustrated, the transmitter 52 and the receiver 53 may be combined into the transceiver 30. The electronic device 10 may also have one or more antennas 55A-55N electrically coupled to the transceiver 30 via the isolation circuitry 54. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 53 may transmit and receive information via other wired or wireline systems or means.

The RFFE 50 may include components of the electronic device 10 that receive as input, output, and/or process signals having radio frequency, including at least some components (e.g., the power amplifier 66, the filter 68) of the transmitter 52, at least some components (e.g., the low noise amplifier 82, the filter 84) of receiver 53, and the isolation circuitry 54. As illustrated, the isolation circuitry 54 is communicatively coupled between the transmitter 52 and the receiver 53, as well as the one or more antennas 55. The isolation circuitry 54 enables signals (e.g., received signals) of a first frequency range received via the one or more antennas 55 to pass through to the receiver 53 and blocks the received signals of the first frequency range from passing through to the transmitter 52. The isolation circuitry 54 also enables signals (e.g., transmission signals) of a second frequency range from the transmitter 52 to pass through to the one or more antennas 55 and blocks the signals of the second frequency range from passing through to the receiver 53. Each frequency range may be of any suitable bandwidth, such as between 0 and 100 gigahertz (GHz) (e.g., 10 megahertz (MHz)), and include any suitable frequencies. For example, the first frequency range (e.g., a transmit frequency range) may be between 880 and 890 MHz, and the second frequency range (e.g., a receive frequency range) may be between 925 and 936 MHz.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

The isolation circuitry 54 may include an antenna tracker 57 that tracks and matches an impedance (e.g., antenna impedance, antenna input impedance) of the one or more antennas 55 to increase isolation between the transmitter 52 and the receiver 53. In some embodiments, antenna impedance may fluctuate over time (e.g., due to environmental effects). To effectively track and match the antenna impedance, the antenna tracker 57 may include one or more tunable components 59 (as illustrated in FIG. 3) that may be adjusted or tuned (e.g., resistive devices such as resistors, inductive devices such as inductors, capacitive devices such as capacitors, and so on) to adjust a resonance frequency and/or an impedance generated by the antenna tracker that matches the antenna impedance. In particular, the processor 12 may adjust or tune the one or more tunable components 59 based on tuning states and/or a tuning algorithm stored in the memory 14 and/or the storage 16. In some embodiments, the tuning states and/or the tuning algorithm may be determined (e.g., calculated, set) based on a detected VSWR measurement at the one or more antennas 55. Furthermore, the tuning states of the one or more tunable components 59 may be stored in a data structure saved in the memory 14 (e.g., lookup table) that enable a target isolation range and target insertion loss range associated with the transmitter 52, the receiver 53, and/or the one or more antennas 55. In additional or alternative embodiments, the tuning algorithm may include one or more algorithms that, when performed, enable the processor 12 to adjust or tune the one or more tunable components 59 to achieve the target isolation range and target insertion loss range associated with the transmitter 52, the receiver 53, and/or the antenna 55. The tuning algorithm may include machine-learning processes, optimization algorithms (e.g., nonlinear optimization algorithms, nonconvex optimization algorithms, deterministic global optimization solver algorithms, and so on), or the like.

FIG. 3 is a schematic diagram of the RFFE 50 of the electronic device 10, according to embodiments of the present disclosure. As described above, the RFFE 50 includes the isolation circuitry 54 that isolates the transmitter 52 from received signals of the first frequency range, and isolates the receiver 53 from transmission signals of the second frequency range, according to embodiments of the present disclosure. The RFFE 50 may include components of the electronic device 10 that receive as input, output, and/or process signals having radio frequency, including at least some components (e.g., a power amplifier, a filter, and so on) of the transmitter 52, at least some components (e.g., a low noise amplifier, a filter, and so on) of the receiver 53, and the isolation circuitry 54. As illustrated, the isolation circuitry 54 is communicatively coupled between the transmitter 52 and the receiver 53, as well as the one or more antennas 55. In addition, as discussed herein, the isolation circuitry 54 may include the antenna tracker 57 with one or more tunable components 59 that may be adjusted or tuned (e.g., resistive devices such as resistors, inductive devices such as inductors, capacitive devices such as capacitors, and so on) to match a detected antenna impedance. The isolation circuitry 54 enables signals (e.g., received signals) of a first frequency range received via the one or more antennas 55 to pass through to the receiver 53 and blocks the received signals of the first frequency range from passing through to the transmitter 52. The isolation circuitry 54 also enables signals (e.g., transmission signals) of a second frequency range from the transmitter 52 to pass through to the one or more antennas 55 and blocks the signals of the second frequency range from passing through to the receiver 53. Each frequency range may be of any suitable bandwidth, such as between 0 and 100 gigahertz (GHz) (e.g., 10 megahertz (MHz)), and include any suitable frequencies. For example, the first frequency range (e.g., a transmit frequency range) may be between 880 and 890 MHz, and the second frequency range (e.g., a receive frequency range) may be between 925 and 936 MHz.

FIG. 4 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted signal 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE), and more specifically, a transmit front end (TXFE) of the electronic device 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

As discussed herein, the transmitter 52 may be communicatively coupled to isolation circuitry 54 and the one or more antennas 55. The isolation circuitry 54 may include the antenna tracker 57 (as illustrated in FIG. 2) that tracks and matches an impedance (e.g., antenna impedance, antenna input impedance) of the one or more antennas 55 to increase isolation between the transmitter 52 and the receiver 53 (as illustrated in FIGS. 2 and 5). In some embodiments, antenna impedance may fluctuate over time (e.g., due to environmental effects). To effectively track and match the antenna impedance, the antenna tracker 57 may include one or more tunable components 59 (as illustrated in FIG. 3) that may be adjusted or tuned (e.g., resistive devices such as resistors, inductive devices such as inductors, capacitive devices such as capacitors, and so on) to adjust a resonance frequency and/or an impedance generated by the antenna tracker that matches the antenna impedance. In particular, the processor 12 may adjust or tune the one or more tunable components 59 based on tuning states and/or a tuning algorithm stored in the memory 14 and/or the storage 16. In some embodiments, the tuning states and/or the tuning algorithm may be determined (e.g., calculated, set) based on a detected VSWR measurement at the one or more antennas 55. Furthermore, the tuning states of the one or more tunable components 59 may be stored in a data structure saved in the memory 14 (e.g., lookup table) that enable a target isolation range and target insertion loss range associated with the transmitter 52, the receiver 53, and/or the one or more antennas 55. In additional or alternative embodiments, the tuning algorithm may include one or more algorithms that, when performed, enable the processor 12 to adjust or tune the one or more tunable components 59 to achieve the target isolation range and target insertion loss range associated with the transmitter 52, the receiver 53, and/or the antenna 55. The tuning algorithm may include machine-learning processes, optimization algorithms (e.g., nonlinear optimization algorithms, nonconvex optimization algorithms, deterministic global optimization solver algorithms, and so on), or the like.

FIG. 5 is a schematic diagram of the receiver 53 (e.g., receive circuitry), according to embodiments of the present disclosure. As illustrated, the receiver 53 may receive received signal 80 from the one or more antennas 55 in the form of an analog signal. A low noise amplifier (LNA) 82 may amplify the received analog signal to a suitable level for the receiver 53 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. The low noise amplifier 82 and/or the filter 84 may be referred to as part of the RFFE, and more specifically, a receiver front end (RXFE) of the electronic device 10.

A demodulator 86 may remove a radio frequency envelope and/or extract a demodulated signal from the filtered signal for processing. An analog-to-digital converter (ADC) 88 may receive the demodulated analog signal and convert the signal to a digital signal of incoming data 90 to be further processed by the electronic device 10. Additionally, the receiver 53 may include any suitable additional components not shown, or may not include certain of the illustrated components, such that the receiver 53 may receive the received signal 80 via the one or more antennas 55. For example, the receiver 53 may include a mixer and/or a digital down converter.

As discussed herein, the range of antenna impedance values detected at the one or more antennas 55 that the antenna tracker 57 may track and match may be restricted (e.g., constrained, limited) due to a type and/or arrangement of components of the antenna tracker 57, such as the one or more tunable components 59, and/or an architecture (e.g., design, formation, structure, couplings, circuit structure) of the components of the antenna tracker 57 (e.g., impedance tuner). For example, certain implemented antenna tracker architectural designs may include one or more tunable capacitors coupled in parallel. However, due to characteristics of the antenna tracker architecture, these arrangements (e.g., architectures, structures) may only result in effective antenna impedance tracking and matching within a limited antenna impedance range (e.g., variable standing wave ratio (VSWR) coverage), and thus may limit sufficient isolation to a smaller range of antenna impedance values. As such, a radio frequency front end (RFFE) may only operate efficiently (e.g., high isolation) within a relatively narrow range of antenna impedance values. Therefore, it is now recognized that an improved antenna tracker architecture is desired that enables antenna impedance tracking and matching over an increased range of antenna impedance values (e.g., thus increasing VSWR coverage) than the range of antenna impedance values for antenna impedance tracking and matching provided by certain antenna trackers having tunable capacitors arranged in parallel. The improved antenna tracker architecture may increase (e.g., extend) an antenna impedance coverage range (e.g., VSWR coverage) of the duplexer and/or increase a range of impedance within which an antenna impedance may be effectively tracked and matched, thus enabling effective isolation between the transmitter and receiver across an increased range of antenna impedance values.

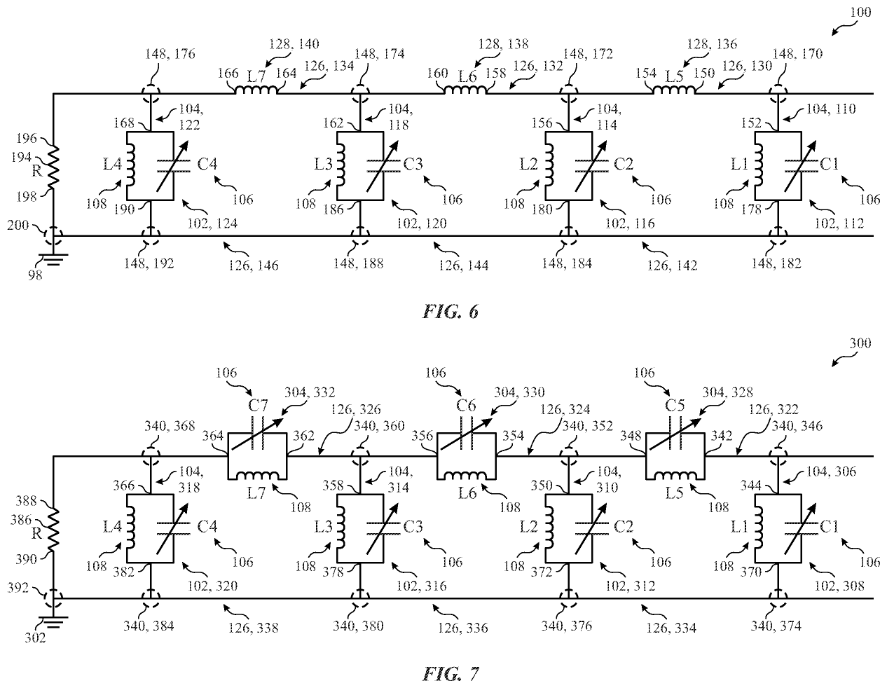

With the foregoing in mind, FIG. 6 is a circuit diagram of a single-ended antenna tracker 100 of an electrical balanced duplexer (EBD) (e.g., isolation circuitry 54) including one or more L-C resonance circuit components 102 each disposed on a respective shunt branch 104 of the single-ended antenna tracker 100, according to embodiments of the present disclosure. The single-ended antenna tracker 100 tracks and matches an antenna impedance (e.g., produces a target impedance that matches a detected antenna impedance) of the one or more antennas 55 over an increased range of antenna impedance values to enable efficient (e.g., high) isolation between the transmitter 52 and receiver 53 across a greater range of antenna impedance values. The single-ended antenna tracker 100 may be an embodiment of the antenna tracker 57, and the EBD may be an example of a duplexer included in the isolation circuitry 54, though the isolation circuitry 54 may include any suitable duplexer used to isolates wireless signals between the transmitter 52 and the receiver 53, such as a phase balanced duplexer (PBD), Wheatstone balanced duplexer (WBD), an electrical balanced duplexer (EBD), a circular balanced duplexer (CBD), and so on.

As discussed herein, the antenna tracker 57 may use various components (e.g., fixed components and/or tunable components) coupled together in differential and/or single-ended configurations to track and match changes in the antenna impedance. In particular, the differential configuration may include a differential input having a first (e.g., high) input and a second (e.g., low) input, where differential voltage is floating because there is no reference to ground, and is measured as a difference between the first and second inputs. On the other hand, a single-ended configuration may include a single (e.g., positive) input and a ground, where single-ended voltage is measured as a difference between the single input and the ground. Embodiments of the differential configurations (e.g., architecture, structure) of the antenna tracker 57 will be discussed further in regards to FIGS. 8-10, while embodiments of the single-ended configurations of the antenna tracker will be discussed with reference to FIGS. 6 and 7.

As illustrated in FIG. 6, the antenna tracker 57 may include the single-ended antenna tracker 100 having the one or more L-C resonance circuit components 102 each disposed on a respective shunt branch 104 of the single-ended antenna tracker 100. In particular, the single-ended antenna tracker 100 may be single-ended and coupled to a ground 98. Furthermore, each of the one or more L-C resonance circuit components 102 may be coupled in parallel with respect to each other. Moreover, each L-C resonance circuit component 102 may include a tunable capacitor 106 coupled in parallel with an inductor 108. In some embodiments, each of the one or more L-C resonance circuit components 102 may provide a respective inductive behavior and/or a respective capacitive behavior based on a desired target impedance. In particular, the inductive behavior of each of the one or more L-C resonance circuit components 102 may be defined by or operate within a first frequency range (e.g., frequency bandwidth), while the capacitive behavior of each of the one or more L-C resonance circuit components 102 may be defined by or operate within a second frequency range different than the first frequency range. In addition, the first frequency range associated with the inductive behavior may have a range of frequency values less than a resonance frequency value, and the second frequency range may have a range of frequency values greater than the resonance frequency value. Moreover, the resonance frequency value associated with each of the one or more L-C resonance circuit components 102 may be adjusted (e.g., changed, shifted) by tuning (e.g., adjusting) a capacitive value of the respective tunable capacitor 106. In particular, the resonance frequency value may be determined based on an inductive value of the inductor 108 and a capacitive value of the tunable capacitor 106. Furthermore, including at least one L-C resonance circuit component 102 in the architecture of the single-ended antenna tracker 100 may enable the single-ended antenna tracker 100 to match an increased range of antenna impedance values, and thus increase an impedance coverage range (e.g., VSWR coverage) of the EBD and enable effective isolation between the transmitter 52 and the receiver 53 across an increased range of antenna impedance values.

Continuing with respect to FIG. 6, the single-ended antenna tracker 100 may include four shunt branches 104, with each shunt branch 104 including a respective L-C resonance circuit component 102 disposed thereon. For example, a first shunt branch 110 includes a first L-C resonance circuit component 112, a second shunt branch 114 includes a second L-C resonance circuit component 116, a third shunt branch 118 includes a third L-C resonance circuit component 120, and a fourth shunt branch 122 includes a fourth L-C resonance circuit component 124. Furthermore, the single-ended antenna tracker 100 may include one or more serial branches 126 coupled between the one or more shunt branches 104, and thus coupled between the one or more respective L-C resonance circuit components 102. In some embodiments, one or more of the serial branches 126 may include a respective serial inductor 128 disposed thereon. In particular, as illustrated in FIG. 6, a first, second, and third serial branch 130, 132, 134 of the one or more serial branches 126 may include a respective first, second, and third serial inductor 136, 138, 140 serially coupled with respect to each other. As illustrated, the first serial inductor 136 is disposed on the first serial branch 130 and coupled between the first shunt branch 110 (e.g., the first L-C resonance circuit component 112) and the second shunt branch 114 (e.g., the second L-C resonance circuit component 116), the second serial inductor 138 is disposed on the second serial branch 132 and coupled between the second shunt branch 114 (e.g., the second L-C resonance circuit component 116) and the third shunt branch 118 (e.g., the third L-C resonance circuit component 120), and the third serial inductor 140 is disposed on the third serial branch 134 and coupled between the third shunt branch 118 (e.g., the third L-C resonance circuit component 120) and the fourth shunt branch 122 (e.g., the fourth L-C resonance circuit component 124). Furthermore, the single-ended antenna tracker 100 may include a fourth serial branch 142 coupling the first shunt branch 110 (e.g., the first L-C resonance circuit component 112) and the second shunt branch 114 (e.g., the second L-C resonance circuit component 116) opposite the first serial branch 130 (e.g., the first serial inductor 136), a fifth serial branch 144 coupling the second shunt branch 114 (e.g., the second L-C resonance circuit component 116) and the third shunt branch 118 (e.g., the third L-C resonance circuit component 120) opposite the second serial branch 132 (e.g., the second serial inductor 138), and a sixth serial branch 146 coupling the third shunt branch 118 (e.g., the third L-C resonance circuit component 120) and the fourth shunt branch 122 (e.g., the fourth L-C resonance circuit component 124) opposite the third serial branch 134 (e.g., the third serial inductor 140).

Additionally, as illustrated in FIG. 6, the one or more serial branches 126 and the one or more shunt branches 104 (e.g., each respective L-C resonance circuit component 102) may be coupled together via a set of nodes 148 (e.g., T-junctions). In particular, one or more terminals of the one or more serial inductors 128 and terminals of the one or more L-C resonance circuit components 102 may be coupled via the set of nodes 148. For example, a first terminal 150 of the first serial inductor 136 may be coupled to a first terminal 152 of the first L-C resonance circuit component 112 via a first node 170, and a second terminal 154 of the first serial inductor 136 may be coupled to a first terminal 156 of the second L-C resonance circuit component 116 via a second node 172. In addition, a first terminal 158 of the second serial inductor 138 may be coupled to the first terminal 156 of the second L-C resonance circuit component 116 via the second node 172, and a second terminal 160 of the second serial inductor 138 may be coupled to a first terminal 162 of the third L-C resonance circuit component 120 via a third node 174. Furthermore, a first terminal 164 of the third serial inductor 140 may be coupled to the first terminal 162 of the third L-C resonance circuit component 120 via the third node 174, and a second terminal 166 of the third serial inductor 140 may be coupled to a first terminal 168 of the fourth L-C resonance circuit component 124 via a fourth node 176. Moreover, the second terminal 154 of the first serial inductor 136 may be coupled to the first terminal 158 second serial inductor 138 by the second node 172, and the second terminal 160 of the second serial inductor 138 coupled to the first terminal 164 of the third serial inductor 140 by the third node 174.

In addition, a second terminal 178 of the first L-C resonance circuit component 112 may be coupled to a second terminal 180 of the second L-C resonance circuit component 116 by a fifth node 182 and a sixth node 184 (e.g., via the fourth serial branch 142). The second terminal 180 of the second L-C resonance circuit component 116 may be coupled to a second terminal 186 of the third L-C resonance circuit component 120 by the sixth node 184 and a seventh node 188 (e.g., via the fifth serial branch 144). Moreover, the second terminal 186 of the third L-C resonance circuit component 120 may be coupled to a second terminal 190 of the fourth L-C resonance circuit component 124 by the seventh node 188 and an eighth node 192 (e.g., via the sixth serial branch 146). In addition, the single-ended antenna tracker 100 may be coupled to the ground 98. In particular, in some embodiments, the single-ended antenna tracker 100 may include a resistor 194 coupled to the ground 98, the one or more L-C resonance circuit components 102, and the one or more serial inductors 128. For example, a first terminal 196 of the resistor 194 may be coupled to both the first terminal 168 of the fourth L-C resonance circuit component 124 and the second terminal 166 of the third serial inductor 140 by the fourth node 176, and a second terminal 198 of the resistor 194 may be coupled to both the ground 98 and the second terminals 178, 180, 186, and 190 of the respective first, second, third, and fourth L-C resonance circuit components 112, 116, 120, 124 by a ninth node 200. In particular, the ninth node 200 may be coupled to the second terminal 190 of the fourth L-C resonance circuit component 124 by the eighth node 192, may be coupled to the second terminal 186 of the third L-C resonance circuit component 120 by both the eighth node 192 and the seventh node 188, may be coupled to the second terminal 180 of the second L-C resonance circuit component 116 by the eighth, seventh, and sixth nodes 192, 188, 184, and may be coupled to the second terminal 178 of the first L-C resonance circuit component 112 by the eighth, seventh, sixth and fifth nodes 192, 188, 184, 182.

FIG. 7 is a circuit diagram of a single-ended antenna tracker 300 of an electrical balanced duplexer (EBD) (e.g., isolation circuitry 54) including the one or more L-C resonance circuit components 102 disposed on both the one or more shunt branches 104 and the one or more serial branches 126 of the single-ended antenna tracker 300, according to embodiments of the present disclosure. Furthermore, the single-ended antenna tracker 300 may be an embodiment of the antenna tracker 57. In particular, the one or more L-C resonance circuit components 102 disposed on the one or more serial branches 126 are referenced herein as one or more serial L-C resonance circuit components 304. In addition, the single-ended antenna tracker 300 of FIG. 7 includes similar couplings and components as the single-ended antenna tracker 100 of FIG. 6, and tracks and matches an antenna impedance of the one or more antennas 55 over an increased range of antenna impedance values to enable effective isolation between the transmitter 52 and receiver 53 across an increased range of antenna impedance values. Including the one or more serial L-C resonance circuit components 304 on the one or more serial branches 126 may increase multi-band performance of the single-ended antenna tracker 300 and/or allow for tracking and matching antenna impedance effectively across multiple frequency bands (e.g., multiple different frequency ranges). Furthermore, the single-ended antenna tracker 300 may be single-ended and coupled to a ground 302. The one or more L-C resonance circuit components 102 disposed on the one or more shunt branches 104 may be coupled in parallel with respect to each other, while the one or more serial L-C resonance circuit components 304 disposed on the one or more serial branches 126 may be coupled in series with respect to each other. Moreover, each L-C resonance circuit component 102 and each serial L-C resonance circuit component 304 may include a tunable capacitor 106 coupled in parallel with an inductor 108. As discussed herein, in some embodiments, each of the one or more L-C resonance circuit components/serial L-C resonance circuit components 102. 304 may provide a respective inductive behavior and/or a respective capacitive behavior based on a desired target impedance. In particular, the inductive behavior of each of the one or more L-C resonance circuit components/serial L-C resonance circuit components 102. 304 may be defined by or operate within a first frequency range (e.g., frequency bandwidth), while the capacitive behavior of each of the one or more L-C resonance circuit components/serial L-C resonance circuit components 102, 304 may be defined by or operate within a second frequency range different than the first frequency range. In addition, the first frequency range associated with the inductive behavior may have a range of frequency values less than a resonance frequency value, and the second frequency range may have a range of frequency values greater than the resonance frequency value. Moreover, the resonance frequency value associated with each of the one or more L-C resonance circuit components/serial L-C resonance circuit components 102, 304 may be adjusted (e.g., changed, shifted) by tuning (e.g., adjusting) a capacitive value of the respective tunable capacitor 106. In such embodiments, including at least one L-C resonance circuit component/serial L-C resonance circuit components 102, 304 in the architecture of the single-ended antenna tracker 100 may enable the single-ended antenna tracker 300 to match an increased range of antenna impedance values, and thus increase an impedance coverage range (e.g., VSWR coverage) of the EBD and enable effective isolation between the transmitter 52 and the receiver 53 across an increased range of antenna impedance values.

Continuing with respect to FIG. 7, the single-ended antenna tracker 300 may include four shunt branches 104 with each shunt branch 104 having a respective L-C resonance circuit component 102 disposed thereon. For example, a first shunt branch 306 includes a first L-C resonance circuit component 308, a second shunt branch 310 includes a second L-C resonance circuit component 312, a third shunt branch 314 includes a third L-C resonance circuit component 316, and a fourth shunt branch 318 includes a fourth L-C resonance circuit component 320. Furthermore, the single-ended antenna tracker 300 may include the one or more serial branches 126 coupled between the one or more shunt branches 104, and thus coupled between the one or more respective L-C resonance circuit components 102. In some embodiments, one or more of the serial branches 126 may include a respective serial L-C resonance circuit component 304 disposed thereon. In particular, as illustrated, a first, second, and third serial branch 322, 324, 326 of the one or more serial branches 126 includes a respective first, second, and third serial L-C resonance circuit component 328, 330, 332 serially coupled with respect to each other. The first serial L-C resonance circuit component 328 is disposed on the first serial branch 322 and coupled between the first shunt branch 306 (e.g., the first L-C resonance circuit component 308) and the second shunt branch 310 (e.g., the second L-C resonance circuit component 312), the second serial L-C resonance circuit component 330 is disposed on the second serial branch 324 and coupled between the second shunt branch 310 (e.g., the second L-C resonance circuit component 312) and the third shunt branch 314 (e.g., the third L-C resonance circuit component 316), and the third serial L-C resonance circuit component 332 is disposed on the third serial branch 326 and coupled between the third shunt branch 314 (e.g., the third L-C resonance circuit component 316) and the fourth shunt branch 318 (e.g., the fourth L-C resonance circuit component 320). Furthermore, the single-ended antenna tracker 300 may include a fourth serial branch 334 coupling the first shunt branch 306 (e.g., the first L-C resonance circuit component 308) and the second shunt branch 310 (e.g., the second L-C resonance circuit component 312) opposite the first serial branch 322 (e.g., the first serial L-C resonance circuit component 328), a fifth serial branch 336 coupling the second shunt branch 310 (e.g., the second L-C resonance circuit component 312) and the third shunt branch 314 (e.g., the third L-C resonance circuit component 316) opposite the second serial branch 324 (e.g., the second serial L-C resonance circuit component 330), and a sixth serial branch 338 coupling the third shunt branch 314 (e.g., the third L-C resonance circuit component 316) and the fourth shunt branch 318 (e.g., the fourth L-C resonance circuit component 320) opposite the third serial branch 326 (e.g., the third serial L-C resonance circuit component 332).

Additionally, as illustrated in FIG. 7, the one or more serial branches 126 and the one or more shunt branches 104 (e.g., each respective L-C resonance circuit component 102) may be coupled together via a set of nodes 340 (e.g., T-junctions). In particular, one or more terminals of the one or more serial L-C resonance circuit components 304 and terminals of the one or more L-C resonance circuit components 102 may be coupled via the set of nodes 340. For example, a first terminal 342 of the first serial L-C resonance circuit component 328 may be coupled to a first terminal 344 of the first L-C resonance circuit component 308 via a first node 346, and a second terminal 348 of the first serial L-C resonance circuit component 328 may be coupled to a first terminal 350 of the second L-C resonance circuit component 312 via a second node 352. In addition, a first terminal 354 of the second serial L-C resonance circuit component 330 may be coupled to the first terminal 350 of the second L-C resonance circuit component 312 via the second node 352, and a second terminal 356 of the second serial L-C resonance circuit component 330 may be coupled to a first terminal 358 of the third L-C resonance circuit component 316 via a third node 360. Furthermore, a first terminal 362 of the third serial L-C resonance circuit component 332 may be coupled to the first terminal 358 of the third L-C resonance circuit component 316 via the third node 360, and a second terminal 364 of the third serial L-C resonance circuit component 332 may be coupled to a first terminal 366 of the fourth L-C resonance circuit component 320 via a fourth node 368. Moreover, the second terminal 348 of the first serial L-C resonance circuit component 328 may be coupled to the first terminal 354 second serial L-C resonance circuit component 330 by the second node 352, and the second terminal 356 of the second serial L-C resonance circuit component 330 coupled to the first terminal 362 of the third serial L-C resonance circuit component 332 by the third node 360.

In addition, the a second terminal 370 of the first L-C resonance circuit component 308 may be coupled to a second terminal 372 of the second L-C resonance circuit component 312 by a fifth node 374 and a sixth node 376 (e.g., via the fourth serial branch 334). The second terminal 372 of the second L-C resonance circuit component 312 may be coupled to a second terminal 378 of the third L-C resonance circuit component 316 by the sixth node 376 and a seventh node 380 (e.g., via the fifth serial branch 336). Moreover, the second terminal 378 of the third L-C resonance circuit component 316 may be coupled to a second terminal 382 of the fourth L-C resonance circuit component 320 by the seventh node 380 and an eighth node 384 (e.g., via the sixth serial branch 338). In addition, the single-ended antenna tracker 300 may be coupled to the ground 302. In particular, in some embodiments, the single-ended antenna tracker 300 may include a resistor 386 coupled to the ground 302, the one or more L-C resonance circuit components 102, and the one or more serial L-C resonance circuit components 304. For example, a first terminal 388 of the resistor 386 may be coupled to both the first terminal 366 of the fourth L-C resonance circuit component 320 and the second terminal 364 of the third serial L-C resonance circuit component 332 by the fourth node 368, and a second terminal 390 of the resistor 386 may be coupled to both the ground 302 and the second terminals 370, 372, 378, and 382 of the respective first, second, third, and fourth L-C resonance circuit components 308, 312. 316, 320 by a ninth node 392. In particular, the ninth node 392 may be coupled to the second terminal 382 of the fourth L-C resonance circuit component 320 by the eighth node 384, may be coupled to the second terminal 378 of the third L-C resonance circuit component 316 by both the eighth node 384 and the seventh node 380, may be coupled to the second terminal 372 of the second L-C resonance circuit component 312 by the eighth, seventh, and sixth nodes 384, 380, 376, and may be coupled to the second terminal 370 of the first L-C resonance circuit component 308 by the eighth, seventh, sixth and fifth nodes 384, 380, 376, 374.

As discussed herein, the single-ended antenna trackers 100, 300 (e.g., each of the one or more L-C resonance circuit components 102 and the one or more serial L-C resonance circuit components) may each include a combination of the one or more tunable components 59, such as each of the tunable capacitors 106, and one or more fixed components, such as the one or more serial inductors 128, each of the inductors 108 of the one or more L-C resonance circuit components 102/serial L-C resonance circuit components 304, and the resistor 194, 386. The one or more tunable components 59 may be adjusted, and, in combination with the one or more fixed components, and may provide or output a range of desired impedance values to substantially match a wide range of detected antenna impedance values of the one or more antennas 55. In other words, due to a wide range of resonance frequencies that the one or more L-C resonance circuit components 102 may be adjusted and/or set to, the single-ended antenna tracker 100 may track and match an increased range of antenna impedance values, and thus increase an impedance coverage range (e.g., VSWR coverage) of the EBD and enable effective isolation between the transmitter 52 and receiver 53 across an increased range of antenna impedance values.

It should be appreciated that although FIGS. 6 and 7 illustrate embodiments of a single-ended antenna tracker 100, 300 that includes four shunt branches 104 each shunt branch 104 including a respective L-C resonance circuit component 102, in some embodiments, the single-ended antenna tracker may include more or less shunt branches (e.g., 1, 5, 6, 10, 20) each with a respective L-C resonance circuit component. In addition, although FIG. 6 illustrates three serial inductors 128 each disposed on a respective serial branch 126, in some embodiments, the single-ended antenna tracker may include more or less serial branches (e.g., 1, 4, 8, 10, 20) each with a respective serial inductor. Similarly, although FIG. 7 illustrates three serial L-C resonance circuit components 304 each disposed on a respective serial branch 126, in some embodiments, the single-ended antenna tracker may include more or less serial branches (e.g., 1, 4, 8, 10, 20) cach with a respective serial L-C resonance circuit component. Furthermore, in some embodiments, the single-ended antenna tracker may include a combination of serial inductors and/or L-C resonance circuit components disposed on the serial branches. In some embodiments, increasing a total number of L-C resonance circuit components disposed on the serial branches and/or the shunt branches may enable an increase in an VSWR coverage by increasing a range of resonance frequencies of the single-ended antenna tracker, thus increasing effectiveness of the single-ended antenna tracker in tracking and matching a substantially wider range of antenna impedances to produce effective isolation between the transmitter and receiver across an increased range of antenna impedance values.

FIG. 8 is a circuit diagram of a differential antenna tracker 400 of an electrical balanced duplexer (EBD) (e.g., isolation circuitry 54) with one or more impedance tanks 402 (e.g., impedance circuits, impedance components) with a portion of the one or more impedance tanks 402 coupled in an X-section architecture 404 (e.g., design, structure, circuit configuration), according to embodiments of the present disclosure. Furthermore, the differential antenna tracker 400 may be an embodiment of the antenna tracker 57. In particular, in some embodiments, the X-section architecture 404 may enable the differential antenna tracker 400 to operate in one or more operational modes, such as in a common mode and/or in a differential mode. For example, the differential antenna tracker 400 may be tuned (e.g., adjusted) to influence a magnitude of a produced impedance (e.g., produced by the differential antenna tracker 400) via a first section 406 of the differential antenna tracker 400 that includes an impedance tank 402 coupled in parallel with respect to the X-section architecture 404. In addition, the differential antenna tracker 400 may be tuned (e.g., adjusted) to influence a phase of the produced impedance (e.g., produced by the differential antenna tracker 400) via a second section 408 of the differential antenna tracker 400 that includes the portion of the one or more impedance tanks 402 arranged in the X-section architecture 404. In such embodiments, the differential antenna tracker 400 may track and match an antenna impedance (e.g., produces a target impedance that matches a detected antenna impedance) of the one or more antennas 55 over an increased range of antenna impedance values to enable efficient (e.g., high) isolation between the transmitter 52 and receiver 53 across a greater range of antenna impedance values.

Moreover, each of the one or more impedance tanks 402 may include any combination of impedance components (e.g., fixed components, passive components, tunable components) to enable effective tracking and matching of antenna impedance. For example, at least one of the one or more impedance tanks 402 may include a tunable capacitor. Additionally or alternatively, at least one of the one or more impedance tanks 402 may include an L-C resonance circuit component 102 having a tunable capacitor 106 coupled in parallel with an inductor 108, as described herein. Including at least one of the L-C resonance circuit components 102 in the X-section architecture 404 may increase multi-band performance of the differential antenna tracker 400 and/or allow for tracking and matching antenna impedance effectively (e.g., high VSWR coverage) across multiple frequency bands (e.g., multiple different frequency ranges). Furthermore, in some embodiments, the impedance tank 402 included in the first section 406 of the differential antenna tracker 400 may be a resistor 410 coupled in parallel with the X-section architecture 404.

Moreover, in some embodiments, the X-section architecture 404 may include four impedance tanks 402 coupled in an ‘X’ circuit structure and/or a figure-8 circuit structure via one or more nodes. In the ‘X’ circuit structure and/or a figure-8 circuit structure described herein may refer to signal pathways crossing over one another when coupling the one or more impedance tanks 402 together. In particular, a first terminal 412 of a first impedance tank 414 of the one or more impedance tanks 402 may be coupled to a first terminal 416 of a second impedance tank 418 of the one or more impedance tanks 402 via a first node 420. Furthermore, a second terminal 422 of the second impedance tank 418 may be coupled to a first terminal 424 of a third impedance tank 426 of the one or more impedance tanks 402 via a second node 428. In addition, a second terminal 430 of the third impedance tank 426 may be coupled to a first terminal 432 of a fourth impedance tank 434 of the one or more impedance tanks 402 via a third node 436, and a second terminal 438 of the fourth impedance tank 434 may be coupled to a second terminal 440 of the first impedance tank 414 via a fourth node 442. Furthermore, the four impedance tanks 402 of the second section 408 may be coupled to the impedance tank 444 (e.g., fifth impedance tank 444) of the first section 406. In particular, a first terminal 446 of the fifth impedance tank 444 of the first section 406 may be coupled to the second terminal 440 of the first impedance tank 414 and the second terminal 438 of the fourth impedance tank 434 of the second section 408 via the fourth node 442. Additionally, a second terminal 448 of the fifth impedance tank 444 may be coupled to the first terminal 424 of the third impedance tank 426 and the second terminal 422 of the second impedance tank 418 of the second section 408 via the second node 428.

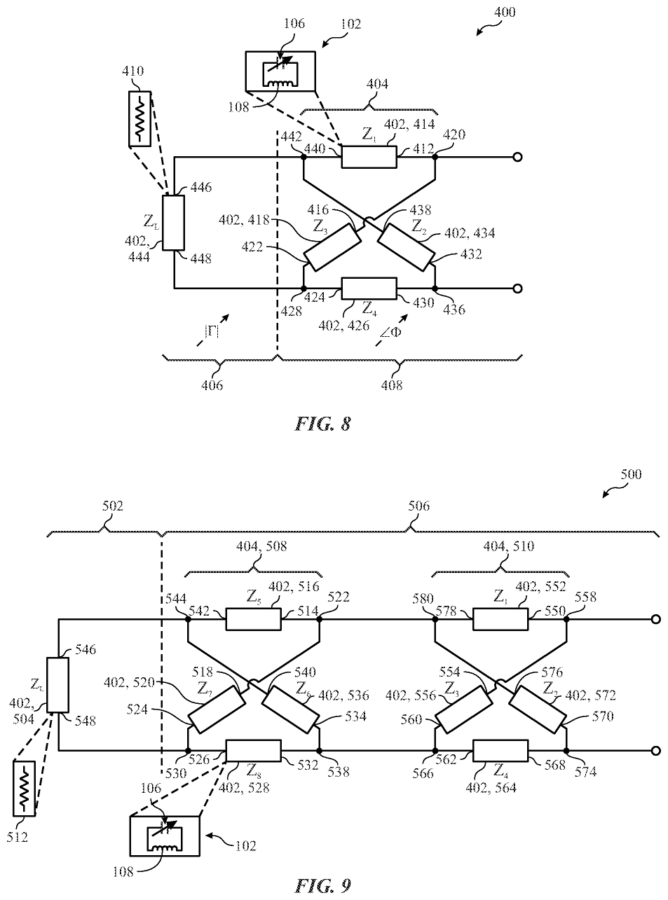

FIG. 9 is a circuit diagram of a differential antenna tracker 500 of an electrical balanced duplexer (EBD) (e.g., isolation circuitry 54) including a first section 502 with an impedance tank 504 of the one or more impedance tanks 402, and a second section 506 with two X-section architectures 404 coupled in series (e.g., series concatenation) with respect to each other, according to embodiments of the present disclosure. Furthermore, the differential antenna tracker 500 may be an embodiment of the antenna tracker 57. In particular, in some embodiments, the differential antenna tracker 500 may include a first X-section architecture 508 coupled in series to a second X-section architecture 510. Furthermore, cach X-section architecture 404 (e.g., the first and the second X-section architecture 508, 510) may be tuned to produce a respective impedance and/or may influence a phase of a target impedance (e.g., target impedance based on a detected antenna impedance). Moreover, cach respective impedance of the first and the second X-section architectures 508, 510 may combine to produce a combined target impedance of the differential antenna tracker 500. In such embodiments, the differential antenna tracker 500 may be configured to effectively track and match an antenna impedance of the one or more antennas 55 over an increased range of antenna impedance values (e.g., high VSWR coverage) to enable effective isolation between the transmitter 52 and receiver 53 across an increased range of antenna impedance values.

Moreover, each of the one or more impedance tanks 402 (e.g., of the first section 502 and/or the first and/or second X-section architectures 508, 510 of the second section 506) may include any combination of impedance components (e.g., fixed components, passive components, tunable components) to enable effective tracking and matching of antenna impedance. For example, at least one of the one or more impedance tanks 402 may include a tunable capacitor. Additionally or alternatively, at least one of the one or more impedance tanks 402 may include an L-C resonance circuit component 102 having a tunable capacitor 106 coupled in parallel with an inductor 108, as described herein. Including at least one of the L-C resonance circuit components 102 in the first and/or section X-section architectures 508, 510 may increase multi-band performance of the differential antenna tracker 500 and/or allow for tracking and matching antenna impedance effectively (e.g., high VSWR coverage) across multiple frequency bands (e.g., multiple different frequency ranges). Furthermore, in some embodiments, the impedance tank 402 included in the first section 502 (e.g., the impedance tank 504) of the differential antenna tracker 500 may include a resistor 512 coupled in parallel with both the first and the second X-section architectures 508, 510.

As discussed herein, cach of the first and the second X-section architectures 508, 510 may include four impedance tanks 402 coupled in an ‘X’ circuit structure and/or a figure-8 circuit structure via one or more nodes. For example, for the first X-section architecture 508, a first terminal 514 of a first impedance tank 516 may be coupled to a first terminal 518 of a second impedance tank 520 via a first node 522 of the one or more nodes. Furthermore, a second terminal 524 of the second impedance tank 520 may be coupled to a first terminal 526 of a third impedance tank 528 via a second node 530 of the one or more nodes. In addition, a second terminal 532 of the third impedance tank 528 may be coupled to a first terminal 534 of a fourth impedance tank 536 via a third node 538 of the one or more nodes, and a second terminal 540 of the fourth impedance tank 536 may be coupled to a second terminal 542 of the first impedance tank 516 via a fourth node 544 of the one or more nodes. Furthermore, the four impedance tanks 402 of the first X-section architecture 508 may be coupled to the impedance tank 504 (e.g., fifth impedance tank 504) of the first section 502. In particular, a first terminal 546 of the fifth impedance tank 504 of the first section 502 may be coupled to the second terminal 542 of the first impedance tank 516 and the second terminal 540 of the fourth impedance tank 536 of the first X-section architecture 508 via the fourth node 544. Additionally, a second terminal 548 of the fifth impedance tank 504 may be coupled to the first terminal 526 of the third impedance tank 528 and the second terminal 524 of the second impedance tank 520 of the first X-section architecture 508 via the second node 530.

Furthermore, for the second X-section architecture 510, a first terminal 550 of a sixth impedance tank 552 may be coupled to a first terminal 554 of a seventh impedance tank 556 via a fifth node 558 of the one or more nodes. Furthermore, a second terminal 560 of the seventh impedance tank 556 may be coupled to a first terminal 562 of an eighth impedance tank 564 via a sixth node 566 of the one or more nodes. In addition, a second terminal 568 of the eighth impedance tank 564 may be coupled to a first terminal 570 of a ninth impedance tank 572 via a seventh node 574 of the one or more nodes, and a second terminal 576 of the ninth impedance tank 572 may be coupled to a second terminal 578 of the sixth impedance tank 552 via an eighth node 580 of the one or more nodes. Furthermore, the four impedance tanks 402 of the second X-section architecture 510 may be coupled to the four impedance tanks 402 of the first X-section architecture 508. In particular, the first terminal 514 of the first impedance tank 516 and the first terminal 518 of the second impedance tank 520 of the first X-section architecture 508 may be coupled to the second terminal 576 of the ninth impedance tank 572 and the second terminal 578 of the sixth impedance tank 552 of the second X-section architecture 510 via the first node 522 and the eighth node 580. Additionally, a second terminal 532 of the third impedance tank 528 and the first terminal 534 of the fourth impedance tank 536 of the first X-section architecture 508 may be coupled to the first terminal 562 of the eighth impedance tank 564 and the second terminal of the seventh impedance tank 556 of the second X-section architecture 510 via the third node 538 and the sixth node 566.

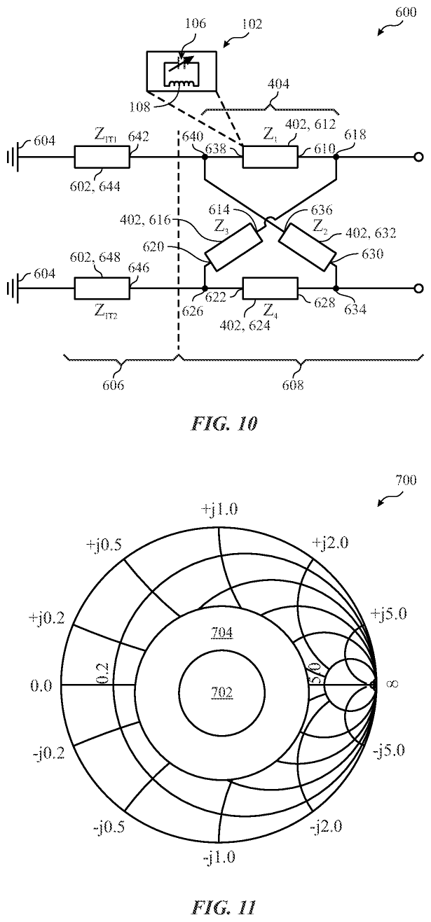

With the foregoing in mind. FIG. 10 is a circuit diagram of an antenna tracker 600 of an electrical balanced duplexer (EBD) (e.g., isolation circuitry 54) with one or more impedance tanks 402 (e.g., impedance circuits, impedance components) coupled in an X-section architecture 404 (e.g., design, structure, circuit) coupled to one or more impedance tuners 602, according to embodiments of the present disclosure. Furthermore, the antenna tracker 600 may be an embodiment of the antenna tracker 57. In particular, the one or more impedance tuners 602 may increase a common mode tuning capability of the antenna tracker 600. In some embodiments, the differential X-section architecture 404 may enable the antenna tracker 600 to operate in one or more operational modes, such as in a common mode and/or in a differential mode. For example, the antenna tracker 600 may be tuned (e.g., adjusted) to influence a magnitude of a produced impedance (e.g., produced by the antenna tracker 600) via a first section 606 of the antenna tracker 600 that includes the one or more impedance tuners 602 coupled to the ground 604 (e.g., one or more single-ended impedance tuners). In addition, the antenna tracker 600 may be tuned (e.g., adjusted) to influence a phase of the produced impedance (e.g., produced by the antenna tracker 600) via a second section 608 of the antenna tracker 600 that includes the one or more impedance tanks 402 arranged in the X-section architecture 404. In such embodiments, the antenna tracker 600 may be configured to effectively track and match an antenna impedance of the one or more antennas 55 over an increased range of antenna impedance values (e.g., increase VSWR coverage) to enable effective isolation between the transmitter 52 and receiver 53 across an increased range of antenna impedance values.

Moreover, each of the one or more impedance tanks 402 may include any combination of impedance components (e.g., fixed components, passive components, tunable components) to enable effective tracking and matching of antenna impedance. For example, at least one of the one or more impedance tanks 402 may include a tunable capacitor. Additionally or alternatively, at least one of the one or more impedance tanks 402 may include an L-C resonance circuit component 102 having a tunable capacitor 106 coupled in parallel with an inductor 108, as described herein. Including at least one of the L-C resonance circuit components 102 in the X-section architecture 404 may increase multi-band performance of the antenna tracker 600 and/or allow for tracking and matching antenna impedance effectively (e.g., high VSWR coverage) across multiple frequency bands (e.g., multiple different frequency ranges). Furthermore, in some embodiments, one or more of the impedance tuners 602 included in the first section 606 of the antenna tracker 600 may be an embodiment of the single-ended antenna tracker 100, 300 as described in FIGS. 6 and 7. In such embodiments, a phase of an impedance produced by the antenna tracker 600 may be tuned (e.g., adjusted) by the X-section architecture 404 of the second section 608 and the magnitude of the produced impedance may be tuned (e.g., adjusted) by the one or more impedance tuners 602 coupled to the ground 604 of the first section 606. In some embodiments, the first section 606 and the second section 608 may interact with one another in terms of the phase and the magnitude to produce a desired impedance. As such, due to the one or more impedance tuners 602 included in the first section 606, the antenna tracker 600 may more effectively track and match (e.g., produce a desired target impedance) an impedance detected at the one or more antennas 55 to enable effective isolation between the transmitter 52 and receiver 53 across an increased range of antenna impedance values.

As discussed herein, in some embodiments, the X-section architecture 404 may include four impedance tanks 402 coupled in an ‘X’ circuit structure and/or a figure-8 circuit structure via one or more nodes. In particular, a first terminal 610 of a first impedance tank 612 of the one or more impedance tanks 402 may be coupled to a first terminal 614 of a second impedance tank 616 of the one or more impedance tanks 402 via a first node 618 of the one or more nodes. Furthermore, a second terminal 620 of the second impedance tank 616 may be coupled to a first terminal 622 of a third impedance tank 624 of the one or more impedance tanks 402 via a second node 626 of the one or more nodes. In addition, a second terminal 628 of the third impedance tank 624 may be coupled to a first terminal 630 of a fourth impedance tank 632 of the one or more impedance tanks 402 via a third node 634 of the one or more nodes, and a second terminal 636 of the fourth impedance tank 632 may be coupled to a second terminal 638 of the first impedance tank 612 via a fourth node 640 of the one or more nodes. Furthermore, the four impedance tanks 402 of the second section 608 may be coupled to the one or more impedance tuners 602 of the first section 606. In particular, a first terminal 642 of a first impedance tuner 644 of the first section 606 may be coupled to the second terminal 638 of the first impedance tank 612 and the second terminal 636 of the fourth impedance tank 632 of the second section 608 via the fourth node 640. Additionally, a first terminal 646 of a second impedance tuner 648 of the first section 606 may be coupled to the first terminal 622 of the third impedance tank 624 and the second terminal 620 of the second impedance tank 616 of the second section 608 via the second node 626.

It should be appreciated that although FIGS. 8-10 illustrate one X-section architecture 404 (FIGS. 8 and 10) or two X-section architectures 404 (FIG. 9) coupled in a series concatenation, in other embodiments, the antenna tracker may include any number of X-section architectures (e.g., 3, 4, 5, 6, 10, 20) so as to effectively track and match an antenna impedance to produce effective isolation between the transmitter and receiver across an increased range of antenna impedance values. Furthermore, is should be appreciated that any number of the one or more impedance tanks of the antenna trackers of FIGS. 8-10 may include a L-C resonance circuit components (e.g., 1, 2, 3, 4, 10) to produce a desired performance of effective tracking and matching an antenna impedance to produce effective isolation between the transmitter 52 and receiver 53 across an increased range of antenna impedance values. In some embodiments, the greater the number of X-section architectures 404 included in the antenna tracker and/or the greater the number of L-C resonance circuit components included in each of the X-section architectures 404, the greater an impedance coverage range (e.g., VSWR coverage) of the antenna tracker, and thus the greater the range of antenna impedance values within which the EBD can produce effective (e.g., high) isolation between the transmitter and receiver.

FIG. 11 is a Smith diagram 700 of a first impedance coverage range or area 702 of an antenna tracker having tunable capacitors arranged in parallel compared to a second impedance coverage range or arca 704 of the antenna tracker 57 as disclosed herein (e.g., antenna tracker 100, 300, 400, 500, 600), according to embodiments of the present disclosure. In particular, the first and the second impedance coverage areas 702, 704 are produced by respective antenna trackers under similar conditions, such as at a same frequency band and with a same antenna type. However, the second impedance coverage area 704 is significantly larger than the first impedance coverage area 702. As discussed herein, the antenna tracker 57 of the present embodiments includes at least one of the L-C resonance circuit components 102, each L-C resonance circuit component 102 including the tunable capacitor 106 and the inductor 108 coupled in parallel. In some embodiments, the antenna tracker 57 may be single-ended (e.g., include at least one ground coupling), such as the single-ended antenna tracker 100 and the single-ended antenna tracker 300 discussed with reference to FIGS. 6 and 7, respectively. In some embodiments, the antenna tracker 57 may include differential components, such as the differential antenna tracker 400, the differential antenna tracker 500, and the antenna tracker 600 as discussed with reference to FIGS. 8, 9, and 10, respectively. As discussed herein, the disclosed architecture of the antenna tracker 57 that may include the one or more L-C resonance circuit components 102 and/or one or more X-section architectures 404 enables the antenna tracker 57 to effectively track and match an increased range of antenna impedances, thus increasing the antenna impedance coverage range or area, such as illustrated by the second impedance coverage area 704, as compared to the range of antenna impedances, such as illustrated by the first impedance coverage area 702, covered (e.g., matched) by the previously discussed antenna trackers having tunable capacitors arranged in parallel.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A communication device, comprising:
one or more antennas;
communication circuitry; and
an antenna tracker coupling the one or more antennas to the communication circuitry, the antenna tracker comprising a first L-C resonance circuit coupled in parallel with a second L-C resonance circuit.

2. The communication device of claim 1, wherein the antenna tracker comprises a resistor coupled in parallel to the first L-C resonance circuit and the second L-C resonance circuit, the resistor coupled to a ground.

3. The communication device of claim 1, wherein the antenna tracker comprises an inductor coupled in series with the first L-C resonance circuit and the second L-C resonance circuit.

4. The communication device of claim 1, wherein the antenna tracker comprises a third L-C resonance circuit coupled in series with the first L-C resonance circuit and the second L-C resonance circuit.

5. The communication device of claim 4, where the first L-C resonance circuit, the second L-C resonance circuit, and the third L-C resonance circuit each comprises a tunable capacitor coupled in parallel with an inductor.

6. The communication device of claim 1, wherein the first L-C resonance circuit is disposed on a first shunt branch of the antenna tracker, the second L-C resonance circuit disposed on a second shunt branch of the antenna tracker.

7. The communication device of claim 6, wherein the first shunt branch and the second shunt branch are coupled via a first serial branch and a second serial branch.

8. The communication device of claim 7, wherein a first terminal of the first L-C resonance circuit is coupled to a first terminal of the second L-C resonance circuit via a first node and a second node, the first shunt branch coupled to the first serial branch via the first node and the second shunt branch coupled to the first serial branch via the second node.

9. The communication device of claim 8, wherein the first serial branch comprises a third L-C resonance circuit, the first terminal of the first L-C resonance circuit coupled to a first terminal of the third L-C resonance circuit via the first node, and the first terminal of the second L-C resonance circuit coupled to a second terminal of the third L-C resonance circuit via the second node.

10. A radio frequency front end circuitry, comprising:
transmitter circuitry;
receiver circuitry; and
isolation circuitry configured to couple the transmitter circuitry and the receiver circuitry to one or more antennas, the isolation circuitry comprising a first impedance tank, a second impedance tank, a third impedance tank, and a fourth impedance tank coupled in a first X-section circuit configuration.

11. The radio frequency front end circuitry of claim 10, wherein the first X-section circuit configuration comprises the first impedance tank coupled to the second impedance tank via a first node, the first impedance tank coupled to the third impedance tank via a second node, the fourth impedance tank coupled to the second impedance tank via a third node, and the fourth impedance tank coupled to the third impedance tank via a fourth node.

12. The radio frequency front end circuitry of claim 11, wherein the isolation circuitry comprises a fifth impedance tank, a sixth impedance tank, a seventh impedance tank, and an eighth impedance tank coupled in a second X-section circuit configuration coupled in parallel with the first X-section circuit configuration.

13. The radio frequency front end circuitry of claim 12, wherein the second X-section circuit configuration comprises the fifth impedance tank coupled to the sixth impedance tank via a fifth node, the fifth impedance tank coupled to the seventh impedance tank via a sixth node, the eighth impedance tank coupled to the sixth impedance tank via a seventh node, and the eighth impedance tank coupled to the seventh impedance tank via an eighth node.

14. The radio frequency front end circuitry of claim 13, wherein the first X-section circuit configuration and the second X-section circuit configuration are coupled via the first node and the third node of the first X-section circuit configuration and the sixth node and the eighth node of the second X-section circuit configuration.

15. The radio frequency front end circuitry of claim 11, the first X-section circuit configuration is coupled to a first impedance tuner via the second node and to a second impedance tuner via the fourth node.

16. The radio frequency front end circuitry of claim 15, wherein the first impedance tuner and the second impedance tuner each comprise a ground coupling.

17. The radio frequency front end circuitry of claim 10, wherein the isolation circuitry comprises a resistor coupled in parallel with the first X-section circuit configuration.

18. The radio frequency front end circuitry of claim 10, wherein the first impedance tank, the second impedance tank, the third impedance tank, or the fourth impedance tank comprises an L-C resonance circuit component.

19. The radio frequency front end circuitry of claim 18, wherein the L-C resonance circuit component comprises a tunable capacitor coupled in parallel with an inductor.

20. An antenna tracker for a communication device, comprising:
a first L-C resonance circuit;
a second L-C resonance circuit coupled in parallel with the first L-C resonance circuit; and
a third L-C resonance circuit coupled to the first L-C resonance circuit and the second L-C resonance circuit, the first L-C resonance circuit, the second L-C resonance circuit, and the third L-C resonance circuit each comprising a tunable capacitor coupled in parallel with an inductor.
